(19) United States
(12) Patent Application Publication
(10) Pub. No.: US 2009/0153143 A1
(43) Pub. Date: Jun. 18, 2009

(54) SENSOR ARRAY FOR DETECTING THE STATE OF A BATTERY

(76) Inventors: Juergen HAEFFNER, Gaertringen (DE); Gabriel WETZEL, Korntal-Muenchingen (DE)

Correspondence Address: KENYON & KENYON LLP, ONE BROADWAY, NEW YORK, NY, 10004, US

(21) Appl. No.: 12/326,527

(22) Filed: Dec. 2, 2008

(30) Foreign Application Priority Data
Dec. 18, 2007 (DE) 10 2007 060 940.1

(51) Int. Cl. G01N 27/27

(52) U.S. Cl. 324/427

(57) ABSTRACT

A sensor array for detecting the state of a battery which is situated in the proximity of the pole terminals of the battery for detecting the electrical state variables of the battery. In addition to a measuring path, an electronic circuit is also integrated into the sensor array whose supply voltage is taken directly from the battery, the supply voltage being connected to the electronic circuit via a cutout in such a way that the cutout is integrally joined into the lead of the supply voltage in the housing of the sensor array.

### FIELD OF THE INVENTION

The present invention relates to a sensor array for detecting the state of a battery, in particular as a component of a power management system in motor vehicles.

### BACKGROUND INFORMATION

In order to ascertain the state of a battery in a motor vehicle, known battery sensors or appropriate electronic circuits are used in battery management systems.

For example, it is described in German Patent No. DE 10 2005 039 587 that the state of a battery in the vehicle electrical system of a motor vehicle may be detected using a battery sensor unit. This battery sensor unit as a measuring path having a shunt resistor is directly clamped to a pole terminal of the battery and practically combines the measuring path with the mechanical connecting unit.

Furthermore, German Patent No. DE 10 2006 013 911 describes that a communication path between the detection of the measured values for testing electrical consumers in the motor vehicle and the analysis of these data obtained therefrom via a CAN or LIN bus system of a computer unit is made available.

### SUMMARY OF THE INVENTION

The present invention is directed to a sensor array for detecting the state of a battery which is situated in the proximity of the pole terminals of the battery for detecting the electrical state variables of the battery. The state variables are usually the current, the voltage, and optionally also the temperature of the battery. In order to integrate, in addition to a measuring path, also an electronic circuit into the sensor array whose supply voltage is taken directly from the battery, according to the present invention the supply voltage is advantageously connected to the electronic circuit via a cutout in such a way that the cutout is integrally joined into the lead of the supply voltage in the housing of the sensor array.

The cutout may be a miniature fusing cutout element or switching cutout element soldered into the lead, for example, a so-called 0603 standard size for small components. Alternatively, the cutout may also be a fusing cutout installed in the lead in the form of a constricted printed conductor or may be implemented via other means normally used in circuit technology within the sensor array.

According to the present invention, one or a plurality of batteries may be situated in the electrical power supply of a motor vehicle, the one or the multiple sensor array(s) for detecting the state of the battery(ies) communicating with a power management system of the motor vehicle for exchanging data. A so-called CAN bus or LIN bus typically used in the automobile industry is suitable for communication of the at least one sensor array with the power management system.

The growing number of electrical consumers in motor vehicles often results in a considerably increasing number of failures due to highly discharged or defective batteries. This calls, in general, for a use of a power management system which, in combination with a battery state recognition system, processes the required information from measurable battery variables such as current, voltage, and temperature.

To enhance the reliability of the vehicle electrical system, vehicles are often equipped with an additional battery, one battery being mainly used for the engine start. The second battery is then used for supplying so-called comfort consumers and as a backup for the supply of particularly safety-critical consumers such as, for example, electrohydraulic brakes or so-called x-by-wire systems. To control the power flow of dual-battery vehicle electrical systems of this type, power management systems are then required which have a relatively complex design.

Using these so-called intelligent battery sensors, the battery variables such as current, voltage, and temperature may be detected with a higher degree of accuracy and at a higher sampling rate and, depending on the partial or full partitioning, the function of recognizing the state of the battery may be performed. To allow the remaining tasks to be performed, the higher-level power management system may then communicate with the battery sensor via a simple and cost-effective serial interface, for example, the so-called LIN bus, in a host control unit, for example, the engine control unit.

As mentioned in the introduction to the description, to meet the strict requirements, in particular for voltage measurement, the voltage measuring line is branched off as close as possible to the positive pole of the battery. Since, according to the present invention, the voltage measuring line is also used as a power supply line, a voltage drop on this line should not affect the accuracy of measurement because the accuracy of the state recognition also depends thereon. On the other hand, such a supply line must be protected by a cutout, it being difficult, in particular in the case of a motor vehicle, to install such a cutout on a loose line. Therefore, in the related art, all cutouts are typically situated in a box, mostly far from the battery, for example, under the dashboard, to the left under the steering wheel. However, only part of the current is conducted to this cutout box; the rest, for example, for the starter or from the generator, does not flow through the cutout box. On the other hand, even if the entire current went to the cutout box, the problem of accuracy due to the voltage drop along the line between the positive pole of the battery and the cutout box would still exist.

The cutout installed by integral joint in the housing of the sensor array according to the present invention thus advantageously succeeds in also avoiding the usual contact problems of plug-in cutouts in the cutout box or on a line. Since the current consumption of such a sensor array according to the present invention is very low, this current is usually too low to avoid (cause) corrosion at the connection point of the cutout and thus interfering transition resistances.

### BRIEF DESCRIPTION OF THE DRAWING

FIG. 1 shows a schematic block diagram of a sensor array situated in the area of the battery of a motor vehicle.

### DETAILED DESCRIPTION

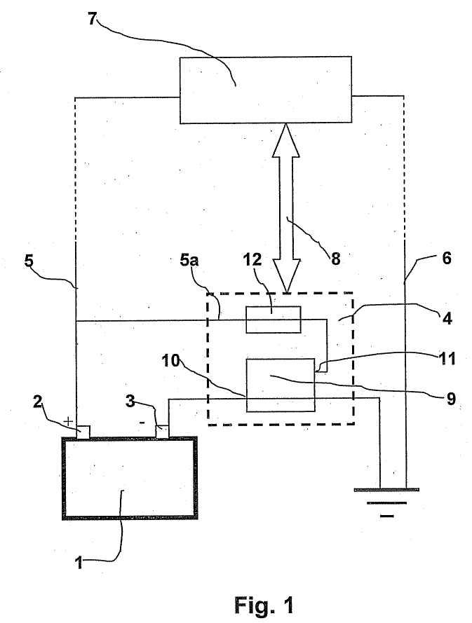

FIG. 1 shows a battery 1 for a motor vehicle whose state is to be detected by measuring electrical variables, in particular current and voltage, as close as possible to pole terminals 2 (+) and 3 (−) of battery 1, having sensor array 4 as a battery sensor. The mechanical positioning directly on pole terminal 2 (+) for measuring current and/or voltage is described in detail, for example, in the above-mentioned related art, German Patent Application No. DE 10 2005 039 587, and is therefore not elucidated in greater detail here.

The consumers connected to battery 1 are then situated behind line 5 (+) and ground line 6 (+) depicted in dashed lines in the following. A power management system 7 which communicates with sensor array 4 via a bus line 8, a LIN bus, for example, is schematically indicated here.

An electronic circuit 9, using which partial analysis or pre-processing of the electrical variables detected on the measured system in the area of circuit 9 may be performed, is located in sensor array 4. The supply voltage is switched here directly to terminals 10 and 11 of electronic circuit 9 and, for this purpose, is taken via line 5a as a positive line from battery 1 via a miniature cutout 12 soldered in the housing of sensor array 4 directly without further contact points. Alternatively, cutout 12 may also be implemented by a fusing cutout in the form of a constricted printed conductor installed in the line of electronic circuit 9. Due to the integral, possibly also due to an integrally installed plug-in cutout, plug-in cutout 12 installed in the housing of sensor array 4, contact problems at cutout 12 are thus avoided.

What is claimed is:

1. A sensor array for detecting a state of a battery, which is situated in a proximity of pole terminals of the battery for detecting electrical state variables of the battery, a supply voltage being taken directly from the battery, the sensor array comprising:
a housing;
a measuring path;
an electronic circuit; and
a cutout, the supply voltage being connected to the electronic circuit via the cutout in such a way that the cutout is integrally joined into a lead of the supply voltage in the housing.

2. The sensor array according to claim 1, wherein the cutout is a miniature fusing cutout element or switching cutout element soldered into a line.

3. The sensor array according to claim 1, wherein the cutout is a fusing cutout in the form of a constricted printed conductor installed in a line.

4. The sensor array according to claim 1, wherein the cutout includes semiconductor switching component elements installed into a line.

5. The sensor array according to claim 1, wherein the state variables are current, voltage, and temperature of the battery.

6. The sensor array according to claim 1, wherein at least one battery is situated in an electrical power supply of a motor vehicle, and at least one sensor array for detecting a state of the battery communicates with a power management system of the motor vehicle for exchanging data.

7. The sensor array according to claim 6, wherein a CAN bus or LIN bus is used for communication of the at least one sensor array with the power management system via a bus line.
